(19) United States
(12) Patent Application Publication
(10) Pub. No.: US 2016/0135493 A1
(43) Pub. Date: May 19, 2016

(54) APPARATUS, METHOD AND SYSTEM FOR MANUFACTURING FOOD USING ADDITIVE MANUFACTURING 3D PRINTING TECHNOLOGY

(71) Applicant: NATURAL MACHINES, INC., Dover, DE (US)

(72) Inventors: Ching-Ju Kuo, Hsinchu (TW); Szu-Hai Huang, Hsinchu (TW); Tien-Ho Hsu, Hsinchu (TW); Luis Rodriguez, Barcelona (ES); Xavier Olivé, Barcelona (ES); Ching-Yi Mao, Hsinchu (TW); Chia-Ting Chang, Hsinchu (TW); Shih-Chang Chen, Hsinchu (TW); Emilio Sepulveda, Barcelona (ES); Victor Delgado, Barcelona (ES)

(73) Assignee: NATURAL MACHINES, INC., Dover, DE (US)

(21) Appl. No.: 14/893,208

(22) PCT Filed: May 22, 2014
(86) PCT No.: PCT/US14/39170

§ 371 Date: Nov. 23, 2015

Related U.S. Application Data
(60) Provisional application No. 61/827,242, filed on May 24, 2013.

(51) Int. Cl. A23G 1/54; A23L 3/00

(52) U.S. Cl. CPC A23P 1/12; A23P 2001/089; B33Y 10/00

(57) ABSTRACT

A 3D printer system that uses the AM method to print a product using a plurality of materials, each of which is contained in a respective capsule. The capsules are removably inserted into respective capsule holders, each of which includes a heating device for adjusting the temperature of the material, and is releasably held in one of a plurality of stations. A tool fetches individual capsules from and deposits them to their stations, and holds individual capsules for printing the product using a telescopic extrusion apparatus. A memory stores capsule-identifying data, a processor provides position coordinates for positioning of the tool, and a controller moves the tool to the position coordinates. The capsule holders include heating systems for controlling the rheological behavior of the materials based on algorithms executed by the processor.

### TECHNICAL FIELD

The present invention relates to the development and usage of a capsule changer to be used in an additive manufacturing (“AM”) 3D Printer. More specifically, the invention relates to a system and method of selecting, picking and changing capsules to be used in a printing process using an AM 3D printer. The selection is done automatically according to the user design being printed without human intervention.

The present invention further relates to the development and usage of capsule heating system to be used in an AM 3D Printer. More specifically, the invention relates to a system and method of heating a capsule to a determined temperature and maintaining this temperature through the AM 3D printing process. The heating process and the temperature applied is determined by an algorithm that considers previous temperature, container composition, contents of the capsule (material), and heating speed needed.

The present invention still further relates to the development and usage of a telescopic extrusion mechanism to be used in an AM 3D Printer. More specifically, the invention relates to a system and method of extruding materials to be used in a printing process using an AM 3D printer. The extrusion process is performed according to the user design being printed without human intervention.

### BACKGROUND ART

### a. Capsule Changers

Although 3D printers have the ability to print with different materials without human intervention to exchange them, this function normally is achieved by using several tools (one per material) at the same time, thus resulting in undesired extra motors, weight and space needed to accomplish the task. Examples of previously existing 3D printers that allow the usage of more than one material using more than one tool can be found at fab@home (http://fabathome.org), or reprap (http://www.reprap.org), both of them open source projects with an active community.

U.S. Pat. No. 4,135,245 to Kemplin et al. discloses a plotter with an automatic pen changing mechanism, but the pens in Kemplin et al.'s plotters are substantially different than they types of cartridges used for 3D printing, particularly for the 3D printing of food products. Therefore, Kemplin et al.'s automatic pen changing mechanism is not readily adaptable to use in 3D printing.

### b. Capsule Heater

Although 3D printers have the ability to heat the printing material (normally only one material is used in a printer) to a melting point so the printer can complete the printing process, working with food requires a fine control of the rheological behavior of the different ingredients, thus a more complex system must be implemented in order to provide a proper heating process and the required heating temperature for each of the ingredients. Examples of previously existing 3D printers that heat the material to a melting point can be found at fab@home (http://fabathome.org), or reprap (http://www.reprap.org), both of them open source projects with an active community.

### c. Extrusion Mechanism

Although 3D printers have the ability to print with different materials, this function normally is achieved using different methods according to the printing materials being used and the purpose of the printer. Examples of previously existing 3D printers using the AM (additive manufacturing) method with different extrusion mechanisms include fab@home (http://fabathome.org), or reprap (http://www.reprap.org), both of them open source projects with an active community.

### d. Use of 3D Printers in Printing Food Products

The demand for some types of meals is poorly served in some areas. For example, people who prefer or require vegan or vegetarian diets may not have means to access vegan or vegetarian dishes in their community; or people with certain diseases or conditions, including intolerance to some ingredients, may require special care when preparing their meals. To date, 3D printers have not been able to satisfy this demand for several reasons.

Traditionally, cooking involves the use of multiple ingredients, and a series of processes in order to prepare the ingredients. Although 3D printers have been used successfully in printing food using AM technology, none of them can be used in an automated process or use more than two materials simultaneously.

### DISCLOSURE OF THE INVENTION

It is accordingly an object of the invention to provide an AM printer system having the ability to print a design that employs different materials without using multiple tools.

It is another object of the invention to provide an AM printer system able to provide a proper heating process and the required heating temperature for each of the materials in a design printed from multiple materials, for example, the ingredients of a food product.

It is still another object of the invention to provide an AM printer system having the ability to print with different materials using a process that is adjusted according to the parameters of the different materials.

These and other objects according to the invention are achieved by a 3D printer system that uses the AM method to print a product using a plurality of materials in a process defined by a set of directions, wherein each of the materials is contained in a respective capsule and has a plurality of parameters and rheological properties associated therewith, and wherein the parameters define how the printer system handles the material associated with the parameters. The printer system has a plurality of capsule holders, each of which is configured to have a material-containing capsule removably inserted therein and includes a heating device for adjusting the temperature of the material contained in the capsule inserted in the capsule holder based on the parameters and properties associated with the material and the directions.

The printer system further includes a tool capable of fetching, holding and depositing a capsule, and a capsule repository having a plurality of stations, each of which includes means for releasably holding one of the capsule holders, and a sensor for detecting whether the station is occupied by one of the capsules. Movement of the tool to position coordinates causes the tool to deposit a capsule holder and its capsule into an unoccupied station and to fetch a capsule from a station corresponding to user-supplied data or system supplied data. An automatic capsule/material exchanger apparatus is provided, which utilizes the motors that drive the tool (i.e. the motors that ordinarily move the tool to position coordinates) to also perform capsule-changing operations. This obviates the need for extra motors and space for using different materials in the same process.

The capsule exchanging action (fetching and depositing) is performed solely by the movement of the tool to said coordinates.

The printer system still further includes a memory that stores capsule-identifying data, which can be user-supplied and/or automatically-supplied, a processor for providing position coordinates corresponding to an unoccupied station and to the station identified by the end-user supplied data or system supplied data, and a controller for moving the tool to the position coordinates.

The apparatus according to the present invention allows the control of parameters such as heating temperature, heating curve, adaptation to the composition of the capsule and the contents of the capsule (ingredient). Thus, according to the present invention, an automatic capsule heating system is provided in each capsule holder. The automatic capsule heating system for each capsule holder includes a conducting layer, an insulating layer, a heat sensor, and a transducer. The AM printer system utilizes the sensors and transducers plus information gathered by the controller regarding the composition of the capsule and the capsule content (ingredient). This allows the printer system to control the rheological behavior of the ingredients and provide a smoother printing process.

The heating process and heating temperature are determined by the processor using an algorithm that takes into account the composition of the capsule, the material in the capsule, and user preferences, and can be modified during the printing process through an end user interface.

In order to perform the extrusion properly, the tool is equipped with a motor-powered telescopic extrusion mechanism that works together with the capsule heating system to execute the design selected by the end user. The telescopic extrusion apparatus enhances the vertical printing space available without the need of a larger printer system.

### BRIEF DESCRIPTION OF THE DRAWINGS

FIG. 1A is a top plan view of the main components of a 3D printer system in accordance with the present invention.

FIG. 1B is a perspective view of the components of the 3D printer system shown in FIG. 1.

FIGS. 2A-2C are block diagrams showing operative elements of the 3D printer system of FIG. 1.

FIGS. 3A and 3B are perspective views of the tool and stations of the 3D printer system of FIGS. 1A, 1B, and 1D, before and after the tool has fetched a capsule from one of the stations.

FIGS. 4A and 4B are partial perspective views of the tool of FIGS. 3A and 3B, in which the engaging mechanisms are in first and second positions, respectively; and FIG. 4C is a partial perspective view of the tool as shown in FIG. 4B, with a capsule engaged by the engaging mechanism.

FIGS. 5A and 5B are graphic illustrations of patterns of movements of the tool of FIGS. 3A and 3B in performing capsule-fetching and capsule-depositing operations respectively.

FIGS. 6A-6D are diagrammatic illustrations of engagement of the tool with a station of FIGS. 3A and 3B, in fetching a capsule from station.

FIGS. 7A-7D are diagrammatic illustrations of engagement of the tool with a station as shown in FIGS. 3A and 3B, in depositing a capsule into the station.

FIG. 8 shows the arrangement of partial views FIGS. 8A and 8B, which together are a logic flow diagram of a routine carried out by computer program instructions stored in the memory and executed by the processor of the 3D printer system of FIG. 2, for generating position coordinates to which the tool is moved.

FIG. 9A is an exploded view of a capsule holder and the components of the heating system thereof.

FIGS. 9B and 9C are perspective and side elevational views, respectively, of a capsule holder of the 3D printer system shown in FIGS. 1A and 1B.

FIG. 10 shows the temperature evolution of different elements in a typical heating process.

FIG. 11 is a logic flow diagram of a routine stored in the 3D printer system of FIG. 2 for generating the heating process.

FIGS. 12A-12C are enlarged views of the tool and the extrusion mechanism FIG. 1, shown in rest, mid-extended, and fully-extended positions, respectively.

FIG. 13 is a logic flow diagram of a routine stored in the 3D printer system of FIG. 2 for the extrusion process implemented by the tool.

FIG. 14 is a diagrammatic illustration of the capsule identification system of the 3D printer system.

FIG. 15 is a top plan view of a capsule holder and the components of the heating system thereof.

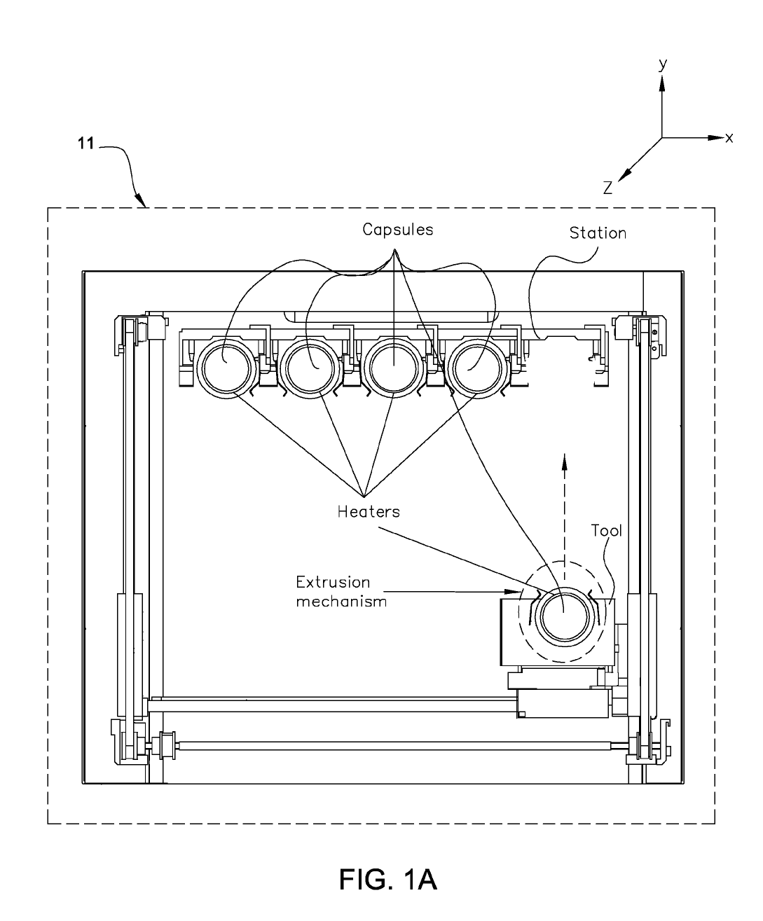

### BEST MODE FOR CARRYING OUT THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

The present invention is described below in part with reference to flowchart illustrations of methods, apparatus (systems), and computer program products according to an embodiment of the invention. It will be understood that each block of the flowchart illustrations, and combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

The programmable data processing apparatus would include typical components such as a bus for communicating information, and a processor coupled with the bus for processing information, random access memory coupled to the bus for storing information and instructions to be executed by the processor. Random Access Memory also may be used for storing temporary variables or other intermediate information during execution of instructions by the processor, a read only memory coupled to the bus for storing static information and instructions for the processor, and a data storage device coupled to the bus for storing information and instructions. Also the system may be coupled via the bus to a display device, such as an LCD monitor or panel, for displaying information to a user. The programmable data processing apparatus further includes a keyboard and a cursor control, or a keypad.

It is to be understood that the present invention is not limited to the illustrated user interfaces or to the order of the user interfaces described herein. Various types and styles of user interfaces may be used in accordance with the present invention without limitation.

The following definitions are used herein:

Controller: a part of the 3D Printer system that communicates with the 3D printer system modules and coordinates and executes the necessary instructions to create the design chosen by the user. It may control motors, sensors and transducers and get information back from each of the modules.

Control panel: a part of the 3D Printer system or an external device that acts as a user interface device and communicates with the controller and some of the 3D printer system modules so to produce a smooth user experience to the end user. It may also interact with the Internet and mobile devices such as smartphones or tablets.

Tool: a tool is an element responsible for the deposition of the different layers whose functionality is ensuring that (1) the material is laid with the proper shape and precision; (2) optionally keep the material at a fixed temperature while being laid; (3) lay down the material at the right speed and place (4) optionally communicate information related to its position and the material extruded to the controller.

Station: a station is an element that stores the capsules that will be used in the printing process together with the capsule heating system whose functionality is ensuring that (1) the capsule is properly stored in its capsule container; (2) identifies each capsule and determines the material contained therein; (3) optionally keep the material at a fixed temperature while being laid; (4) optionally communicate information related to its position and the material extruded to the controller.

Repository: a repository is a group of stations that jointly provide hosting to the capsules being used in the printing process.

Capsule holder: a capsule holder is a container that holds a capsule and embeds various systems that perform tasks as capsule heating, temperature control and capsule identification.

System: a group of interacting, interrelated, or interdependent elements forming a complex whole.

“Ingredient” is used hereinafter in describing the operation of a 3D printer system in the production of a food product according to a recipe, via an additive manufacturing method. However, it will be appreciated by those of skill in the art that the printer system and method of its use can be used to produce non-food products (including, but not limited to such diverse products as soap, wax, and concrete) according to plans, using materials other than the ingredients of food products, and that the use of the terms “recipe” and “ingredient” in the description hereinafter is not intended to limit the invention to the printing of food products, but rather is intended to be non-limiting.

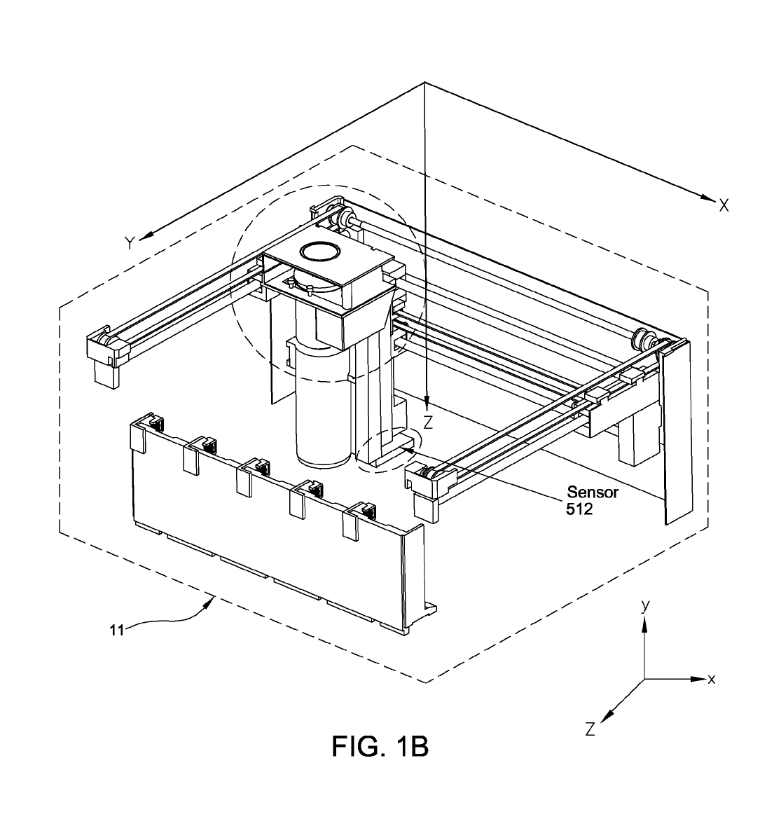

The X-Y-Z 3D printer system 11 of the present invention of the tool 23 according to the present invention comprises a capsule changing system (including a capsule repository 25 and components thereof) (shown schematically in FIG. 2A), a capsule heating system 500 (shown schematically in FIG. 2B), and an extrusion mechanism 511 (shown schematically in FIG. 2C), all of which are described hereinafter in greater detail.

Also included in the system 11 as shared components of the capsule changing system, the capsule heating system, and the extrusion mechanism are a processor 17, a tool 23 for extruding material (that is, the ingredient) from the capsules 59 using a telescopic mechanism 511 (described in detail hereinafter), and a controller 21 for controlling the movement of the tool 23 according to computer program instructions stored in a read-write memory (RWM) 19 of the system 11, as described in greater detail hereinafter. Preferably, the system 11 has the processor 17 embedded therein, but the system 11 can be configured to allow a user's external device (for example, a computer or tablet) to communicate with the processor 17, so that the user can control the system 11 via his or her own device.

a. Capsule Changing System

FIG. 2A shows the printer system 11 with the elements of capsule changers in block diagram form. The system 11 includes a capsule repository 25 with five capsule-storage stations (slots) 27 (individually designated as 27A, 27B, 27C, 27D, 27E) located adjacent to the printing surface for storing capsules 59 therein, each station 27 being equipped with sensors 29 for detecting its status (unoccupied or occupied). Each station 27 is equipped also with a capsule holder 53 that embeds various systems therein (as described below) and has the function of holding the capsules 59 (which are individually designated as 59A, 59B, 59C, 59D, and 59E).

Data identifying the capsules 59 is entered automatically from a capsule identification system 41 (described hereinafter) or manually by the end-user through a user interface 15 (shown diagrammatically as reference number 15 in FIGS. 2A-2C) attached to the system. The entered data is stored in the read write-memory 19 and identifies a station in the repository 25, permitting the selection or fetching of the capsule 59 in that station for use in producing print.

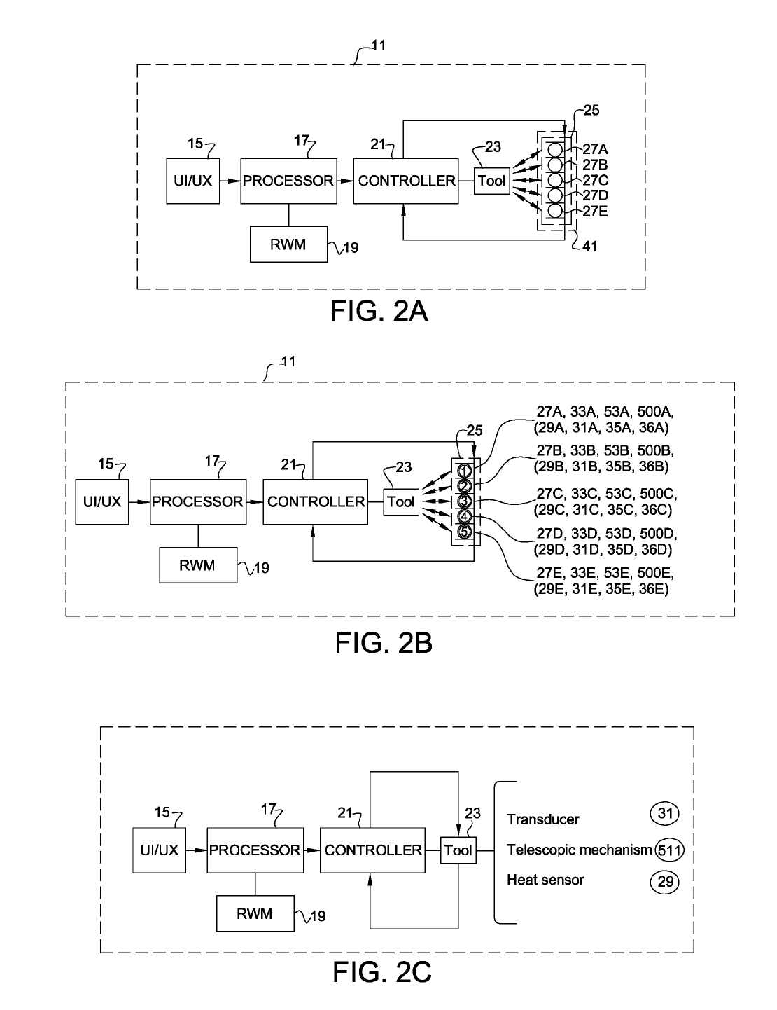

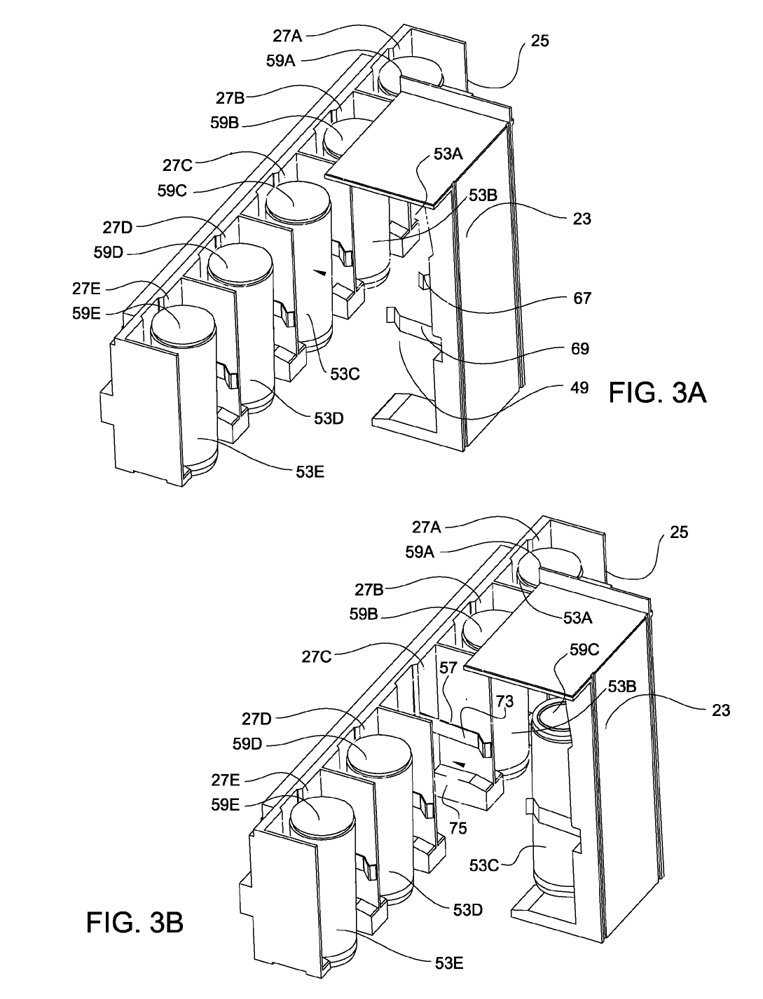

FIGS. 3A and 3B show the capsule repository 25 with a plurality of stations 27 for storing the capsules 59 (individually designated as 59A, 59B, 59C, 59D, and 59E) and their capsule holders 53 (individually designated as 53A, 53B, 53C, 53D, and 53E) and an exchanger mechanism (described in detail hereinafter) for effecting an exchange of one of the capsule holders 53 between one of the stations 27 and the tool 23. The capsule-storage stations 27 (individually designated as 27A, 27B, 27C, 27D and 27E) each contain one capsule holder 53A, 53B, 53C, 53D, and 53E, into which is inserted a respective capsule 59A, 59B, 59C, 59D, and 59E with one of the desired ingredients for carrying out the printing process; the selection of different stations 27 during the printing process, therefore, permits the printing of the design using the different ingredients.

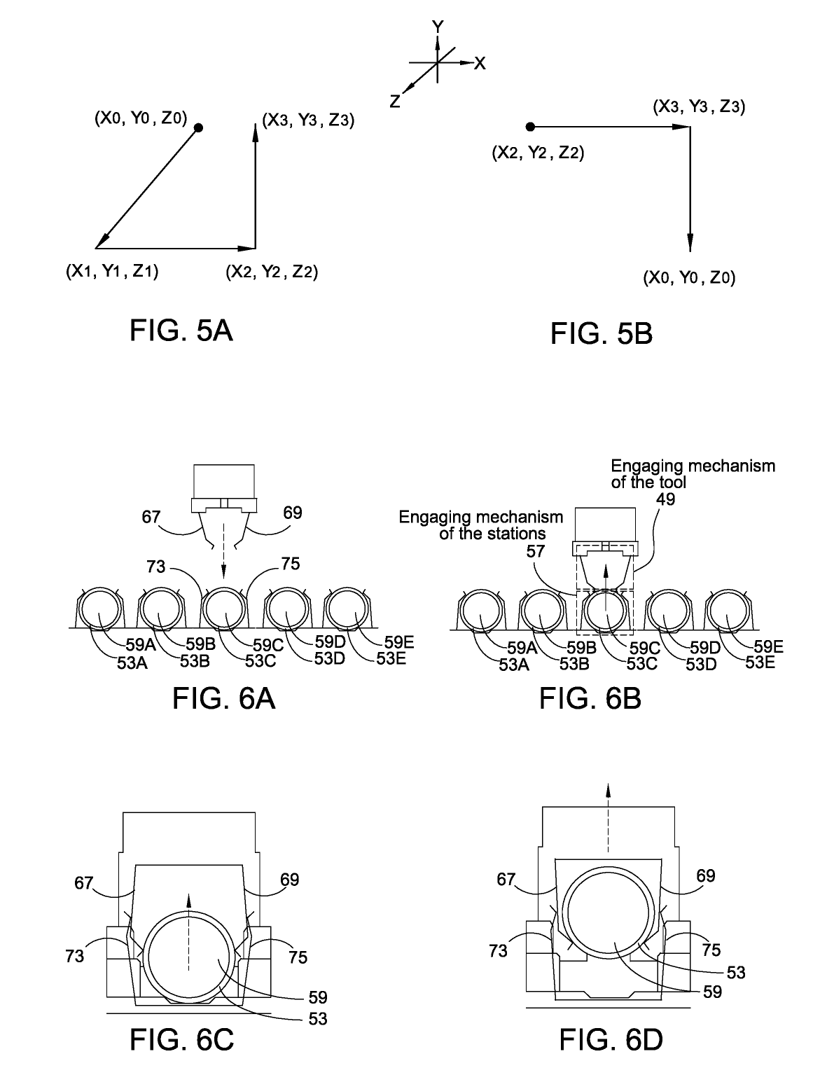

Still referring to FIGS. 3A and 3B, the exchanger mechanism comprises an engaging mechanism 57 located at each station 27 and an engaging mechanism 49 located in the tool 23, used for effecting an exchange of one of the capsule holders 53 and the capsule 59 inserted therein between one of the stations 27 and the tool 23, and for holding the capsule holder 53 and its capsule 59 once the exchange has taken place. The engaging mechanism 49 of the tool 23 comprises a pair of clips, e.g., tension spring arms 67, 69 provided in the tool 23, which are in an untensioned state when not engaged with a capsule holder 53, and which are in a tensioned state when engaged with a capsule holder 53. The engaging mechanism 57 at each of the stations 27, shown in FIGS. 6A, DB, 7A, and 7B, also comprises a pair of clips, e.g., tension spring arms 73, 75, which act upon pressure exercised by the spring arms 67, 69 on the tool 23, as described in greater detail hereinafter.

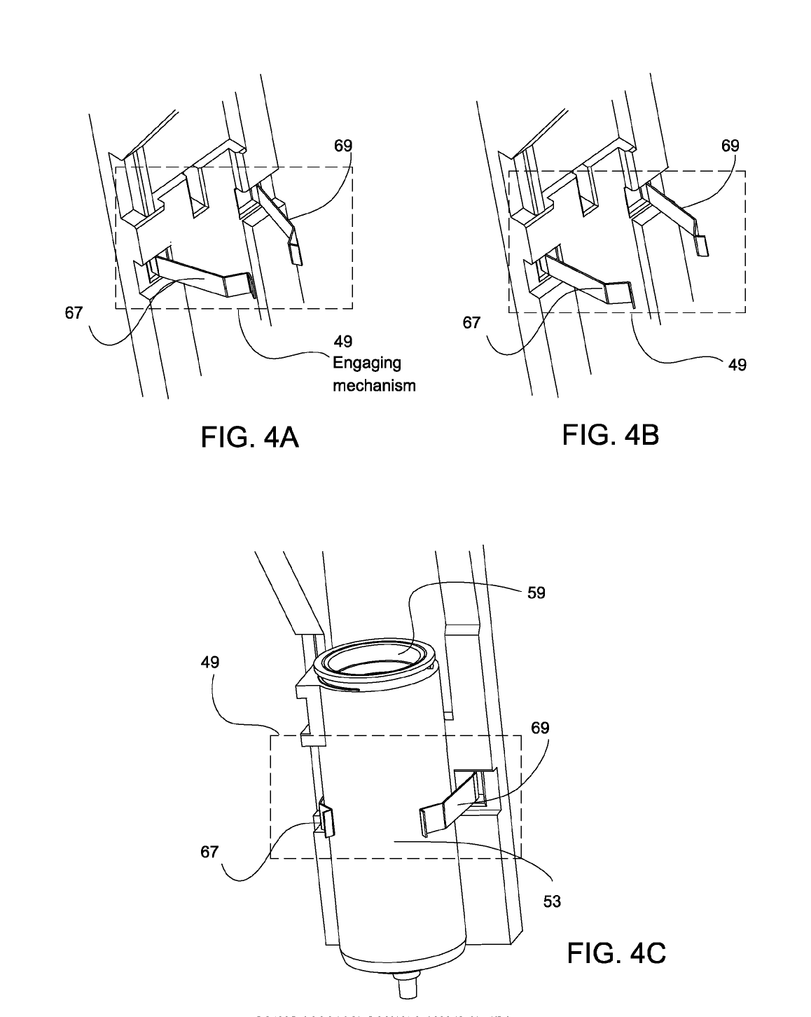

Referring now to FIGS. 5A and 5B, in fetching a capsule holder 53 and the capsule 59 inserted therein from a selected one of the stations 27, the tool 23 is first moved from the position it occupies, for example, from an initial position represented by the coordinate (X0, Y0, Z0), to a position (X1, Y1, Z1) in front of the selected station (in the example shown in FIG. 3A, station 27C). From position (X1, Y1, Z1), the tool 23 is then moved to position (X4, Y4, Z4) as shown in FIG. 5A for fetching the capsule 59C and its capsule holder 53C from the selected station 27C.

To fetch the capsule 59C and its capsule holder 53C from the station 27C (as shown in the example in FIG. 3A), the tool 23 is moved into the station 27C from position (X1, Y1, Z1) to position (X2, Y2, Z2) as shown in FIG. 5A, with the engaging mechanism 49 of the tool 23 engaging the engaging mechanism 57 of the station 27C and depressing the spring arms 73, 75. As shown in FIG. 5A, the tool 23 is then moved laterally from position (X2, Y2, Z2) to position (X3, Y3, Z2) within the station 27C. As shown in FIG. 6, this lateral movement causes the engaging mechanism 49 to come into contact with the capsule-holder 53C and to contiguously advance around said capsule-holder 53C, thereby partially encircling and holding the capsule-holder 53. After encircling and holding the capsule holder 53C, the tool 23 is moved from position (X3, Y3, Z3) to position (X4, Y4, Z4), withdrawing the capsule holder 53C and the capsule 59C within from the station 27C. This capsule and holder-withdrawal movement causes the tension spring arms 67, 69 of the engagement mechanism 49 of the tool 23 to move (in opposition to their own spring tension) from the path of the withdrawn capsule holder 53C and the capsule 59C within, as shown in FIG. 6, thereby causing the station 27C to release the capsule-holder 53C. The movement of the tool 23 from position (X3, Y3, Z3) to position (X4, Y4, Z4) also permits the engaging mechanism 49 to become disengaged from the capsule-holder 53C. From position (X4, Y4, Z4), the tool 23 is moved to its original position (X0, Y0, Z0).

If the tool 23 is already holding a capsule holder 53 and the capsule 59 within, then before fetching the other capsule 59 and its capsule holder 53, it becomes necessary for the tool 23 to first deposit the capsule holder 53 that it is holding and its capsule 59 into an available (unoccupied) station 27. In depositing a capsule 59 and its capsule holder 53 into an available station 27, the tool 23 is moved from a current position (X0, Y0, Z0) to a position (X4, Y4, Z4) in front of the available station 27. From position (X4, Y4, Z4), the tool 23 is then moved to position (X1, Y1, Z1) in an L-shaped pattern as shown in FIG. 5B (the depositing operation being essentially a reverse of the fetching operation). In moving from position (X4, Y4, Z4) to position (X3, Y3, Z4) to deposit the capsule 59 and its capsule holder 53 into the available station 27, for example to deposit the capsule 59C and its capsule holder 53C into the station 27C as shown in FIG. 3B, the engaging mechanism 49 of the tool 23 engages the engaging mechanism 57 of the stations 27 and depresses the engaging mechanism 49 of the tool 23 in preparation for deposit (insertion) of the capsule 59C and its capsule holder 53C into the station 27C. Deposit of the capsule 59C and its capsule holder 53C into the station 27C is accomplished by movement of the capsule holder 53C past the spring arms 73, 75. As the capsule holder 53C, with its capsule 59C, travels from position (X4, Y4, Z4) to position (X3, Y3, Z3) within the station 27C, it comes into contact with the spring arms 73,75 and is moved contiguously past them; this causes the spring arms 73, 75 to first recede from the path of the capsule holder 53C then snap back, partially encircling the capsule holder 53C and holding it in place in the station 27C.

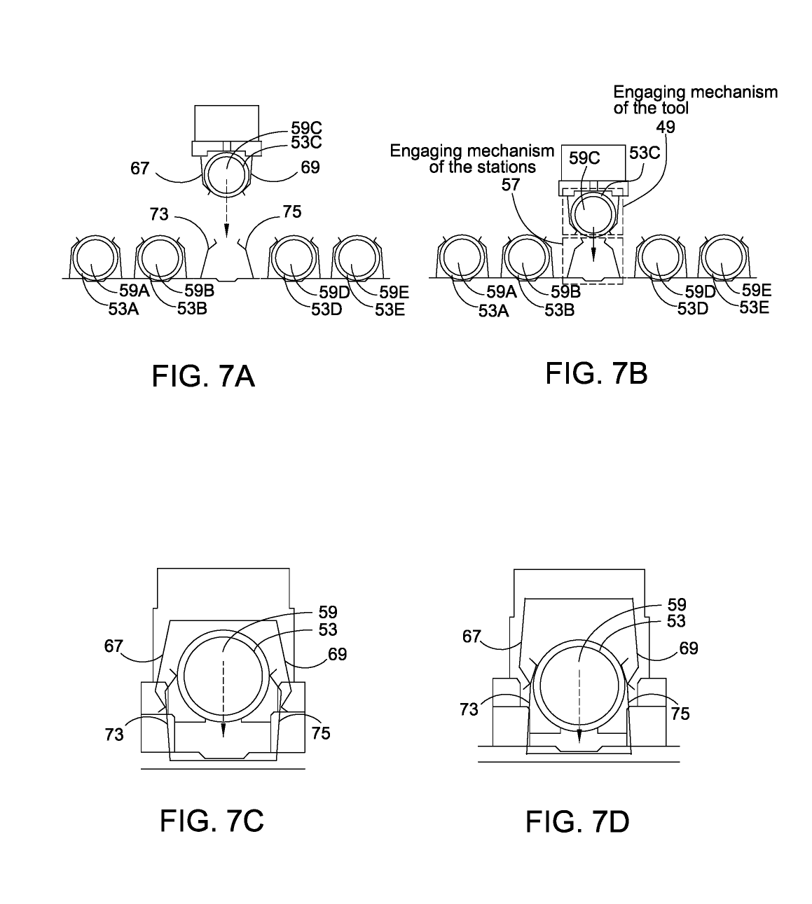

From position (X3, Y3, Z3), as shown in FIG. 5B, the tool 23 is then moved laterally to position (X2, Y2, Z2). This lateral movement causes the spring arms 67, 69 to move contiguously around and away from the capsule holder 53C, thereby releasing the capsule holder 53C as shown in FIG. 7B. From position (X2, Y2, Z2), the tool 23 is then moved to position (X1, Y1, Z1), causing the engaging mechanism 49 of the tool 23 to become disengaged from the engaging mechanism 57 of the station 27. After the capsule 59C has been released, the tool 23 is then moved from position (X1, Y1, Z1) to its initial position (X0, Y0, Z0), thereby completing the deposit operation.

As will be appreciated by those of skill in the art, the exchange process described herein between the station 27C and the tool 23 for the capsule holder 53C and the capsule 59C within is exemplary, a similar exchange process being applicable between all the stations 27 and the tool 23 for all the capsule holders 53 and the capsules 59 therewithin.

Referring now to FIG. 2A, data may be entered into the read-write memory (RWM) 19 of the system 11 from the automatic capsule identification system 41 (as described hereinafter) or from data input by the end-user through the user interface 15 attached to the system 11.

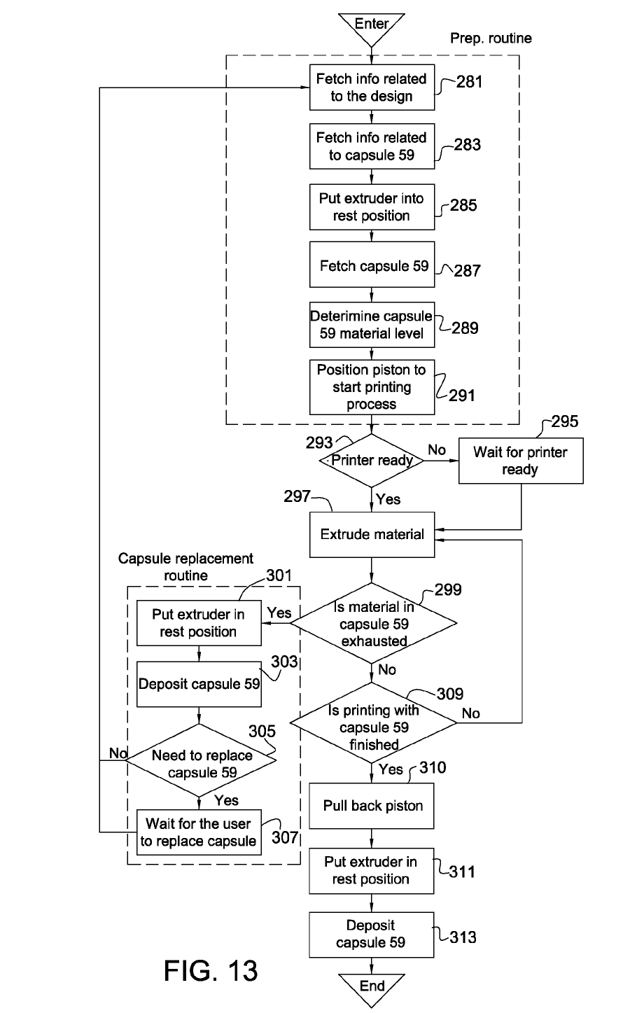

The capsule identification system 41 is shown in FIG. 14, and includes a tag 37 (individually designated as 37A, 37B, 37C, 37D, 37E) integrated into each capsule 59 and a tag reader 39 (individually designated as 39A, 39B, 39C, 39D, 39E) in each station 27. The tag 37 stores a unique code, which is associated with data stored in a database external to the system 11. This externally-stored data associates a capsule 59 with the ingredient contained therein, as well as the expiration date of the ingredient, how much of the ingredient contained in the capsule has been used before and the origin of the capsule (including, but not limited to, manufacturer and shipping date). The tag reader 39 in each station 27 retrieves the data from the tag 37 integrated in each capsule 59 and the RWM 19 receives and stores the data retrieved by the tag readers 39. The system 11 also permits the end-user to enter data associating a capsule 59 with the ingredient contained therein, via the user interface 15.

The processor 17 uses this data stored in the RWM 19 to identify which capsule 59 is in each station 27. Therefore, the system 11 knows what ingredient is available in each station 27, and also which stations 27 are occupied; and can detect if the required ingredients for the current print job are available in the stations 27.

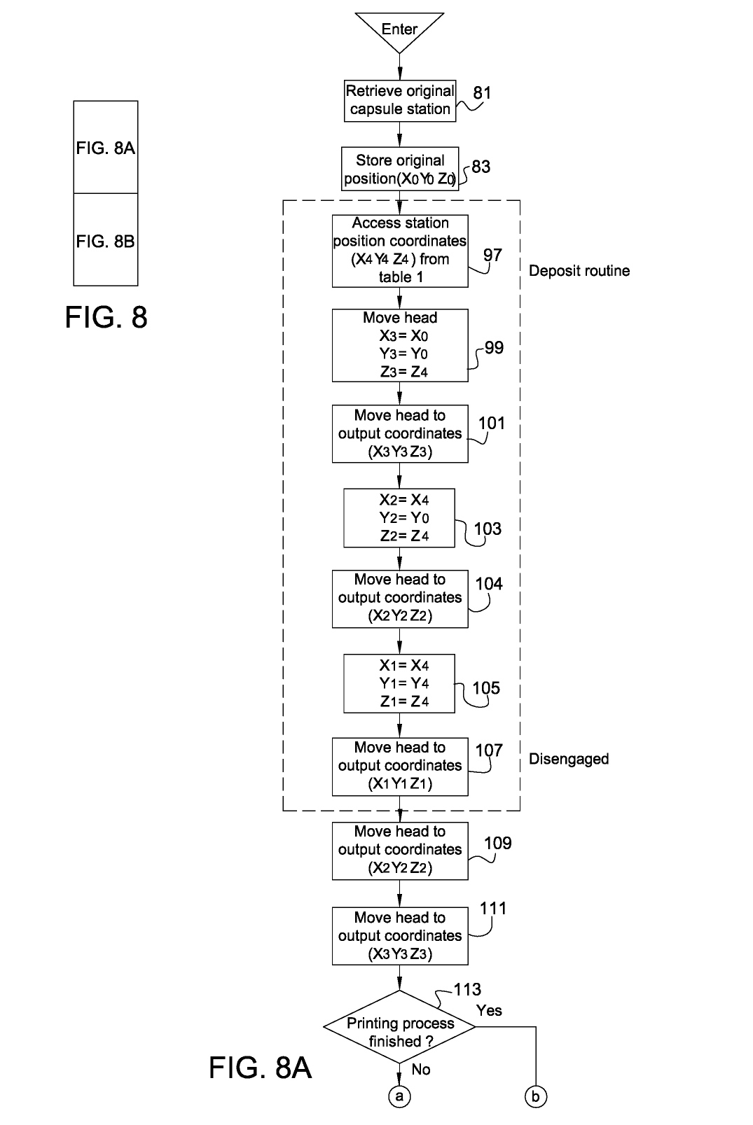

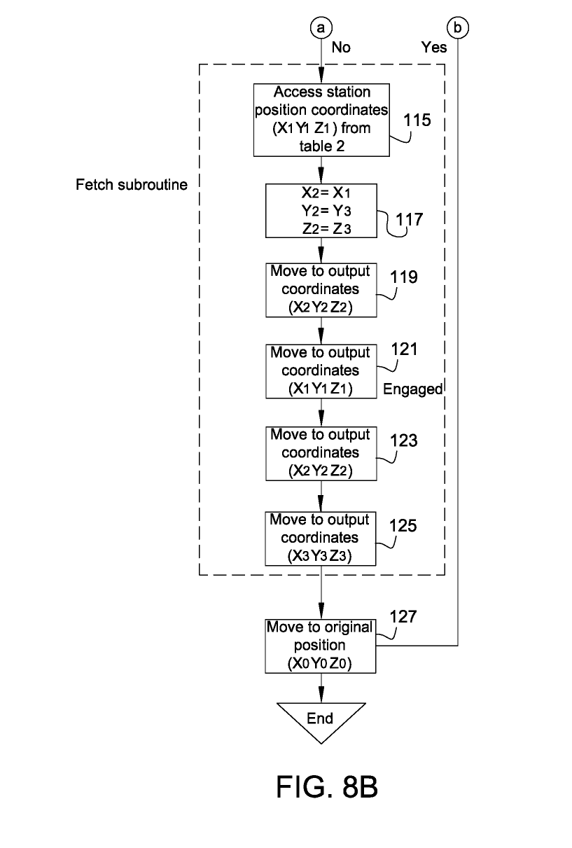

If the required ingredients are available, the system 11 can start the printing process, which will run automatically until its completion unless one of the ingredients required is exhausted, in which case the system 11 requires the end-user to replace the capsule 59 that contained the said ingredient. In case there are some missing ingredients, the system 11 asks the end user to put the proper capsules 59 containing those ingredients into the stations 27. The printing process then starts by the system 11 selecting the first capsule 59 to be used; and controller 21 moves tool 23 in order to fetch the capsule 59 in its capsule holder 53 from its associated station 27. After the capsule 59 has been used, the controller 21 moves the tool 23 in order to deposit the capsule 59 in its capsule holder 53 into back into its associated station 27, and proceeds to fetch the next required capsule 59 in its capsule holder 53. Prior to the fetching action, if the tool 23 is already holding another capsule holder 53 and the capsule 59 therein, the processor 17 causes the controller 21 to deposit them into their associated unoccupied station 27, as described above. These exchange operations of depositing and fetching, which are performed under control of a routine stored in the read-write memory (RWM) 19 of the system 11, are described below and shown in flow chart (logic flow diagram) form in FIGS. 8A and 8B.

Referring now to FIGS. 8A and 8B together, a logic flow diagram of the routine stored in the memory 19 for carrying out the exchange operations of depositing and fetching is described. This routine generates the position coordinates to which the tool 23 is moved when exchanging a capsule holder 53 and the capsule 59 therein between a station 27 and the tool 23. In the following description, the specific capsules 59 and capsule stations 27 are exemplary only, and are not limiting of the process generally. Also in the following description, the blocks of the flow diagram are referred to as “steps,” as they represent the steps in carrying out the process in accordance with the present invention.

The routine is entered, starting at step 81, each time a printing command that requires a capsule change is entered into the processor 17. At step 81, the position coordinates associated with the original capsule station 27C are retrieved, so the processor 17 knows where to deposit the capsule. From step 81, control is transferred to step 83 where the current position (X0, Y0, Z0) of the tool 23 is retrieved and then stored in the memory 19 of the processor 17 for later use.

At step 97, the position coordinates (X4, Y4, Z4) of the associated station 27 for the capsule 59 are accessed from the controller 21 for commencing the depositing operation. A series of four position coordinates are generated by the processor 17. These position coordinate values for commencing depositing operations with respect to the five stations 27A, 27B, 27C, 27D, 27E shown in FIG. 2, are used in Table 1 below. For example, the coordinates (X4, Y4, Z4) to which the tool 23 must be moved when starting to deposit a capsule holder 53C with its capsule 59C into the station 27C (the third station shown in FIG. 2A) would be (1100, 500, 400). These coordinates correspond to those of the third station (station 27C) used in Table 1.

TABLE 1
Position coordinates for depositing a capsule

| Station | X4 | Y4 | Z4 |
|---|---|---|---|
| 27A | 900 | 500 | 400 |
| 27B | 1000 | 500 | 400 |
| 27C | 1100 | 500 | 400 |
| 27D | 1200 | 500 | 400 |
| 27E | 1300 | 500 | 400 |

Following the operation at step 97, control is then transferred to step 99. As step 99 shows, the values for the X and Y-coordinates are adjusted and value for the Z-coordinate is unadjusted to produce the position coordinates (X3, Y3, Z3), which are sent to the controller 21 (FIG. 2A) as position coordinates (X3, Y3, Z3). In step 101 of FIG. 8A, the tool 23 is moved to this new position designated by the position coordinates (X3, Y3, Z3). In step 103 the X coordinate is adjusted and the Y and Z coordinate values remain unchanged to produce the position coordinate pair (X2, Y2, Z2), which are sent to controller 21 (FIG. 2A) as position coordinates (X2, Y2, Z2). In step 104 of FIG. 8A, the tool 23 is moved to this new position. In step 105 the Y coordinate is adjusted and the X and Z coordinate values remain unchanged to produce the position coordinates (X1, Y1, Z1), which are sent to the controller 21 (FIG. 2A). In step 107 of FIG. 8, the tool 23 is moved to this new position.

This movement of the tool 23 to the position coordinates (X1, Y1, Z1), as shown in FIG. 5B, causes the capsule holder 53C and its capsule 59C held in the tool 23 to be deposited into the station 27C, the station 27C being the station assigned to the capsule holder 53C and its capsule 59C contained in the tool 23. Subsequent to the above capsule-depositing operation, control is transferred from step 107, to step 109 where the tool 23 is moved back to position (X2, Y2, Z2) and in step 111 is moved back to the position (X3, Y3, Z3) where the tool 23 waits for further instructions.

Control is then transferred to step 113, where a test is made to determine if the printing process has finished or another capsule 59 is to be fetched from a station 27. If the printing process has already finished, there is no need to fetch another capsules 59 and the control is transferred to step 127. In case the printing process is not finished, another capsule holder 53 and its capsule 59 must be fetched; and control is transferred to step 115. At step 115, the position coordinates (X1, Y1, Z1) of the station 27C for commencing the fetching operation are accessed from the controller. A series of four position coordinate values are generated by the processor 17. These position coordinate values for commencing fetching operations with respect to the five stations 27A, 27B, 27C, 27D, 27E shown in FIG. 2A, are used in Table 3 below. For example, the coordinates (X1, Y1, Z1) to which the tool 23 must be moved when fetching the capsule holder 53D and its capsule 59D from the station 27D (the fourth station shown in FIG. 2A) would be (1200, 500, 400). These coordinates correspond to those of the fourth station (station 27D) used in Table 2.

TABLE 2
Position coordinates for fetching a capsule

| Selected | | | |
|---|---|---|---|
| Station | X1 | Y1 | Z1 |
| 27A | 900 | 500 | 400 |
| 27B | 1000 | 500 | 400 |
| 27C | 1100 | 500 | 400 |
| 27D | 1200 | 500 | 400 |
| 27E | 1300 | 500 | 400 |

Thereafter, as shown in FIGS. 5A and 8B, in step 117, the value of the X-coordinate is adjusted and the values of the X and Z-coordinates remain unadjusted to produce the position coordinates (X2, Y2, Z2), which are sent to the controller 21 as position coordinates (X2, Y2, Z2). In step 119, the tool 23 is moved to the new position coordinates (X2, Y2, Z2). Afterwards, as shown in step 121, coordinates (X1, Y1, Z1) are sent to the controller 21, thus the tool 23 is moved to these coordinates, thereby fetching the capsule holder 53D and its capsule 59D in the station 27D.

Subsequently, in step 123, the coordinates (X2, Y2, Z2) are sent to the controller 21 and the tool 23 is moved back to the coordinates (X2, Y2, Z2); and in step 125, the coordinates (X3, Y3, Z3) are sent to the controller 21 and the tool 23 is moved back to the coordinates (X3, Y3, Z3).

Following the operation performed at step 125, in step 127, the tool 23 is returned to its original position (X0, Y0, Z0); this original position corresponds to the values of the position coordinates previously stored in the internal memory 19 of the processor 17, as indicated by step 83.

From step 127, exit is made from the routine.

The status of the tool 23 is also checked at the time of commencement of use of the system 11 (i.e., at initialization or “power turn-on” time) by movement of the tool 23 to origin position (0, 0, 0).

b. Capsule Heating System

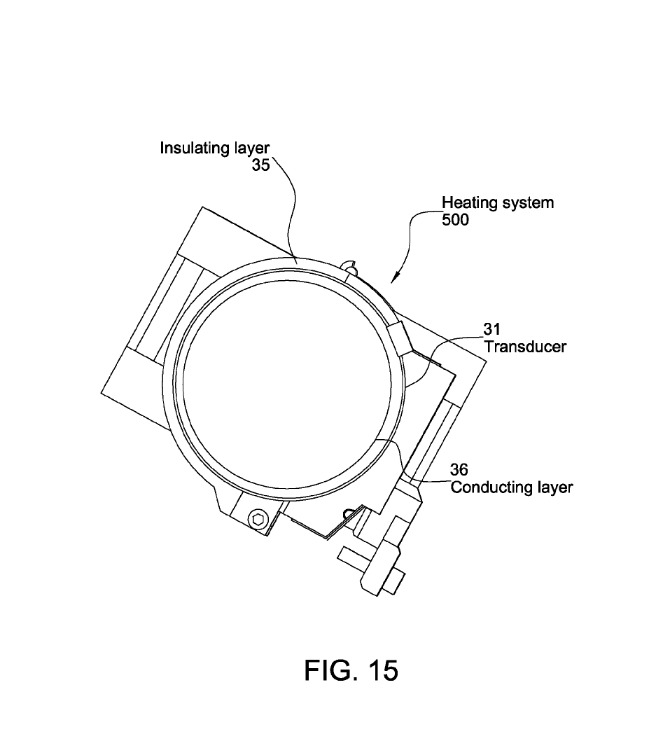

Automatic capsule heating systems 500 (individually designated 500A, 500B, 500C, 500D, 500E) are provided in the capsule holders 53. The automatic capsule heating system 500 for each capsule holder 53 is shown in FIGS. 3A, 3B, and 15, and comprises a conducting layer 36 on the interior of the capsule holder 53, an insulating layer 35 on the exterior of the capsule holder 53, a heat sensor 29, and a transducer 31 inserted into the interior of the capsule holder 53, as discussed in greater detail below.

FIG. 2B shows the printer system 11 with the elements of the heating system 500 in block diagram form. The UI/UX 15, the processor 17, the controller 21, the tool 23, and the stations 27A, 27B, 27C, 27D and 27E are as described above in connection with FIG. 2A. FIGS. 3B and 3C show the components of the heating systems 500A, 500B, 500C, 500D, and 500E in greater detail, including the respective heat sensors 29A, 29B, 29C, 29D, and 29E for each of the capsule holders 53A, 53B, 53C, 53D, and 53E; and respective transducers (thermal mesh) 31A, 31B, 31C, 31D, and 31E for each of the capsule holders 53A, 53B, 53C, 53D, and 53E. The heat sensor 29 measures the temperature of the capsule holder 53, from which the temperature of the ingredient in the capsule 59 can be inferred. The heat sensor 29 and the transducer (thermal mesh) 31 are both embedded into each capsule holder 53 and connected through the spring pin connector 33 to the station 27 if the capsule 59 of the capsule holder 53 is idle, or to the tool 23 if the capsule 59 of the capsule holder 53 is in use. The spring pin connector 33 is responsible for receiving the power from the controller 21 and transmitting capsule temperature information from the heat sensor 29 to the controller 21.

When the controller 21 pushes current to the transducer 31, the transducer 31 heats up. The insulating layer 35 limits the effect of the transducer 31 to the capsule 59 and prevents heat from the transducer 31 being leaked to the rest of the system 11. The conducting layer 36 ensures that the heat produced by the transducer 31 is transferred to the capsule 59 contained in capsule holder 53. The printer system 11 utilizes the heat sensors 29 and the transducers 31, plus information gathered by the controller 21 regarding the composition of the capsules 59 and the contents of the capsules 59 (the ingredients) to control the rheological behavior of the ingredients and provide a smoother printing process.

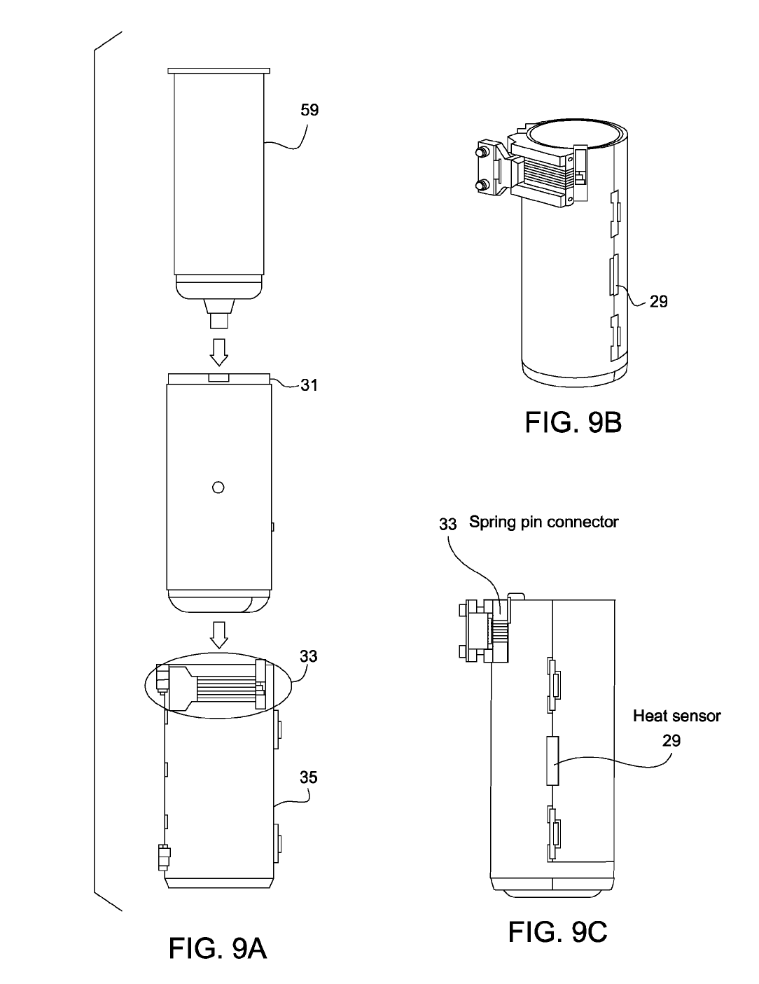

FIG. 10 shows the temperature evolution of the transducer 31 and the temperature evolution of the capsule 59 in a typical heating process, with different curves for each.

Each of the ingredients contained in the capsules 59 has a set of some fifteen parameters associated with it, including but not limited to printing temperature, heating curve, extrusion speed, extrusion multiplier, waiting time between layer deposition, axis speed, optimal nozzle diameter, vertical precision, horizontal precision, viscosity curve, density, freezing temperature, melting temperature, etc., which parameters define how the printer system 11 handles the ingredient. It is noted that the heating temperature of an ingredient is not necessarily the same as its printing temperature. Some ingredients may be preheated by the heating system 500 while in the station 27, and then heated by the heating system 500 at a different temperature, normally higher, when printing begins.

The parameters for each ingredient are all stored in the RWM 19. In heating a capsule 59 in a selected station 27, the processor 17 uses the stored parameters, coupled with the information (i.e. temperature evolution curves like the ones shown in FIG. 10) related to the recipe selected by the end user to determine, using an algorithm stored in the read-write memory (RWM) 19 of the system 11, the optimal heating process for the ingredient while in the station 27 and while in the tool 23. The algorithm is related to the rheological properties of the ingredient, which can readily be determined by a person with ordinary skill in the technology. This algorithm adjusts the heating curve so as to minimize the time required to reach the desired temperature without altering the properties of the ingredient. For example, it may be more efficient to heat the capsule 59 initially to a temperature higher than the desired temperature of the ingredient, and wait for the ingredient to reach the desired temperature (for example, when the ingredient is chocolate, the capsule 59 is heated to 40° C. and then allowed to cool down to 28° C. as part of the process of tempering the chocolate). This higher temperature of the capsule 59 cannot be so high as to produce chemical changes in the ingredient. Also, there are some ingredients that, due to their poor conductivity, prevent the use of this sort of process (in which the capsule 59 is initially heated to a higher temperature than the desired temperature of the ingredient). Thus, the algorithm takes all this information (the stored parameters for each ingredient and the temperature evolution curves of the transducer 31, the capsule 59, and the nozzle 510) into account to determine, for each ingredient, the optimal heating curve.

The heating process is executed for each of the capsules 59, even for the capsules 59 that are not in use, and starts with the ingredient printing temperature being received by the processor 17 from the RWM 19. The processor 17 then uses the temperature of the capsule 59 as measured by the heat sensor 29 as input to a proportional-integral-derivative (PID) algorithm to control the heating system 500 to achieve a stable target temperature in the capsule 59.

Once the heating process has been defined, the processor 17 dispatches commands to the controller 21, which proceeds to push current to the transducer 31 and receives temperature information from the heat sensor 29A, 29B, 29C, 29D and 29E in real time. This temperature information is sent back to the processor 17, which adjusts the heating process automatically according to the new temperature information received from the heat sensor 29 and proceeds to send new commands to the controller 21 in a continuous process.

The end user has the option to alter (through the user interface 15) both the temperature that must be applied to each ingredient and also the parameters associated with a given ingredient. If the end user inputs a new temperature and/or new parameters, the processor 17 proceeds to update the heating process to be applied and accordingly sends commands to the controller 21 for the updated heating process.

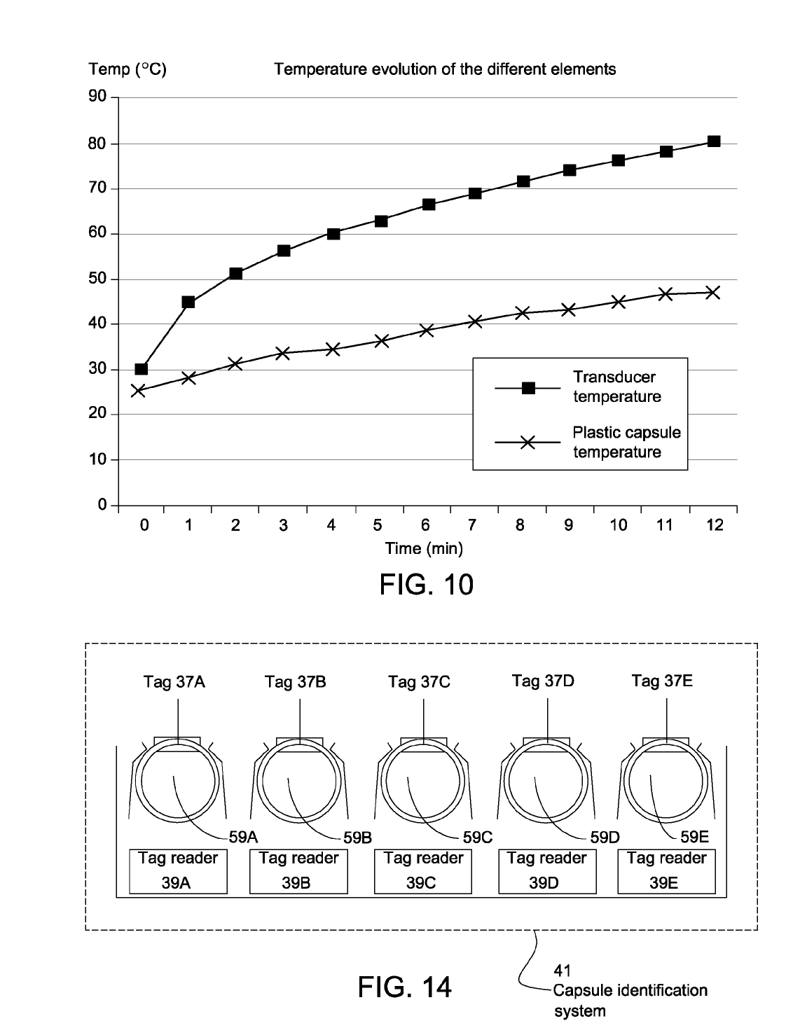

This heating process is performed under control of routine for carrying out a heating process algorithm, which is implemented by computer program instructions stored in the read-write memory (RWM) 19, and is described below and shown in flow chart (logic flow diagram) form in FIG. 11. This routine is carried out for each of the capsules 59 present in the system 11, even if they are not in use at a given moment.

The routine for carrying out the heating process is entered, starting at step 181, each time data or a command that involves heating an ingredient is entered into the processor 17. At step 181, the recipe information is fetched from the read-write memory (RWM) 19 of the system 11 embedded in the processor 17. The routine is carried out for each of the capsules 59, even those that are not in use. This recipe information includes the ingredients to be used in the recipe, and in which order the ingredients are going to be used. From step 181, control is transferred to step 183, where the information related to the ingredient contained in the capsule 59, including the temperature information needed to determine the heating process, is also fetched from the RWM 19. This information fetching step 183 is performed for every capsule 59 in the system 11, so the system 11 knows which capsule 59 should be used next. Once all information relevant to the heating process has been collected, control is transferred to step 185 where a test is made, utilizing the sensors 512 contained in the tool 23 (shown in FIG. 2C), to determine if the capsule 59 is already in use.

If the capsule 59 is in use, a printing temperature control sub-routine is entered, with control being transferred from step 185 to step 187, where a further test is made to determine if the capsule temperature has already reached the desired temperature according to the information previously fetched in steps 183 and 185. If the result of the test is that the temperature is below the desired printing temperature, control is transferred to step 189 where the temperature is increased to the desired level; and then control is transferred to step 191, where the printing job continues. If, on the other hand, the capsule temperature was already adequate, control is transferred directly to step 191. Subsequent to this printing temperature control sub-routine, control is transferred to step 201, where a test is performed to determine if the printing job with capsule 59 has finished. If the result of this test is that the printing job has not finished, control is transferred back to step 187 and the printing temperature control sub-routine starts over again. Otherwise, if the printing job with capsule 59 has finished, control is transferred to step 203, where the capsule 59 is released and control is transferred back to step 185.

If the result of the test in step 185 is that the capsule is not in use, control is transferred to a station preparation sub-routine at step 205, where a further test is made to determine if the capsule temperature has already reached the desired station temperature according to the information previously fetched in steps 183 and 185. If the result of the test is that the temperature is below the desired station temperature, control is transferred to step 207, where the temperature is increased to the desired level, and then control is transferred to step 209, where the temperature status is updated. If, on the other hand, the capsule temperature was already adequate, control is transferred directly to step 209. Once the station preparation sub-routine is completed, control is transferred to step 211, where a test is performed to determine if the printing job has finished. If the result of this test is that the printing job has not yet finished, control is transferred back to step 185 and the routine for carrying out the heating process continues as previously described. Otherwise, if the printing job is completed, control is transferred to step 213, where the device waits until the capsule cools down to a safe temperature. From step 131, exit is made from the routine for carrying out the heating process.

c. Extrusion Mechanism

FIG. 2C shows the printer system 11 with the elements of the extrusion mechanism in block diagram form. The extrusion mechanism comprises an actuator in the form of a telescopic mechanism 511, which is part of the tool 23, in combination with the heat sensors 29 and the transducers 31 previously described. The telescopic mechanism 511 actuates extrusion of the material from the capsule held in the capsule holder.

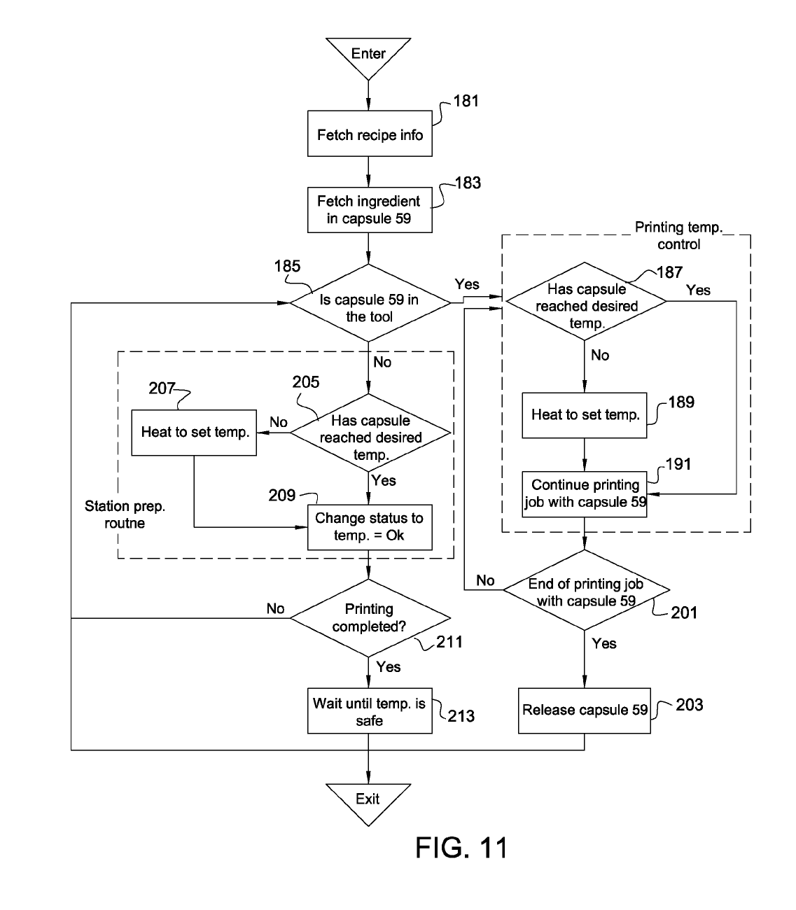

FIGS. 12A-12C show the telescopic mechanism 511 of tool the 23 in greater detail, in three different positions: a rest (retracted) position (FIG. 12A), mid-extended position 53 (FIG. 12B), and a completely extended position (FIG. 12C). When the telescopic mechanism 511 is extended, it pushes a capsule piston 51 at the upper end of the capsule 59, thus producing the extrusion of the ingredient from the lower end of the capsule 59. Extension and retraction of the telescopic mechanism 511 are achieved by way of a motor 61 included in the extrusion mechanism.

In order to perform a printing job, it becomes necessary for the tool 23 to adjust the temperature of the printing material (the ingredient in the capsule 59) through the heating system 500, and to extrude the ingredient using the incorporated telescopic mechanism 511. Parameters corresponding the optimum capsule temperature achieved through the heating system 500 and speed at which the telescopic mechanism 511 must deploy are determined by the processor 17 through an algorithm that takes into account the ingredient being used, the design being printed and, eventually, the end user input (if any). The temperature control system starts with the ingredient printing temperature received by the processor 17. The heat sensor 29 then measures the temperature of the capsule 59. Through a proportional-integral-derivative (PID) algorithm, which assesses the slope of the heating curve (gradient), the processor 17 controls the heating system 500 to achieve a stable target temperature in the capsule 59. The telescopic mechanism 511 speed is determined by the processor 17 through a trapezoid movement algorithm. This trapezoid movement algorithm uses as an input the design being printed and an ingredient-specific extrusion multiplier parameter, which allows the extrusion speed to be linearly modified throughout the printing process in accordance with ingredient-specific properties such as viscosity, density, and/or chunkiness; and it outputs the proper deployment of the telescopic mechanism 511 with the right speed and displacement. The telescopic mechanism 511 also has a sensor 512 for detecting whether the ingredient being extruded has been exhausted, in which case it will inform the controller 21, which will the pass a token to the processor 17. The processor 17 will then determine the next action to be performed according to the previously described algorithm.

It will often be necessary for the tool 23 to deposit the capsule 59 and its capsule holder 53 into its corresponding station 27 before fetching another capsule 59 and its capsule holder 53 from its station 27 in order to continue the printing job. In depositing a capsule 59 and its holder 53 into its corresponding station 27, the tool 23 must restore the telescopic mechanism 511 to its rest position, so that the capsule holder 53, and with it the capsule 59, can be released. This is achieved by means of the controller 21 ordering the motor to retract the telescopic mechanism 511 to its retracted (rest) position, in which it is at its shortest extension.

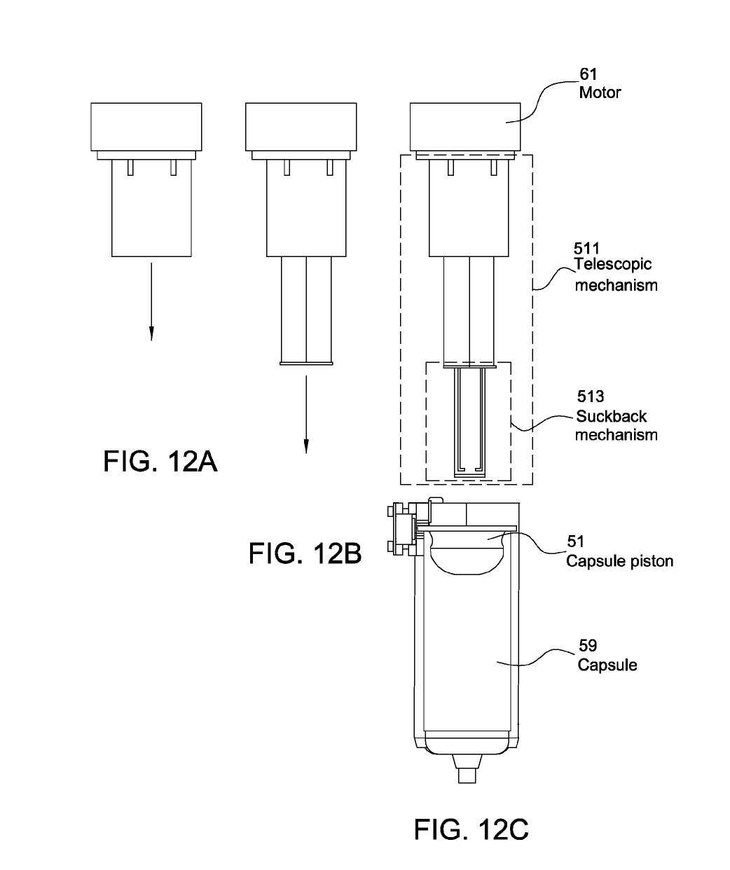

The extrusion operation, which is performed under control of an extrusion operation algorithm stored in the RWM 19 of the processor 17, is described below and shown in flow chart (logic flow diagram) form in FIG. 13. Prior to the extrusion operation, as a part of the printing process, a determination is made which ingredient is to be used and which capsule 59 the ingredient is in, and the parameters for the ingredient are retrieved from storage (i.e., from the RWM 19).

The algorithm for the extrusion operation is entered each time data or a command that involves an extrusion operation or an operation with a capsule 53 and its capsule holder 59 (such as fetching from or returning to its station 27) is received or executed by the processor 17. The extrusion routine starts at step 281 with a preparation sub-routine. At step 281, the recipe information is fetched from the RWM 19 in the processor 17. This recipe information includes all the ingredients to be used in the recipe and the order in which they are going to be used. From step 281, control is transferred to step 283, where the extrusion parameters (extrusion speed, extrusion multiplier) related to the ingredient contained in the capsule 59 are also fetched. Once all relevant extrusion parameters have been collected, control is transferred to step 285 where the controller 21 puts the telescopic mechanism 511 into its rest position. Afterwards, control is transferred to step 287, where the capsule 59 and its holder 53 are fetched. In step 289, the telescopic mechanism 511 determines, utilizing sensor 512, the level of ingredient in capsule 59. Control is transferred then to step 291, where the controller 21 positions the telescopic mechanism 511 in the proper starting position, so the printing process can start. More specifically, in step 291, the controller 21 provides to the tool 23 a succession of instructions containing the coordinates of the starting position, so the tool 23 moves to the proper (x, y, z) position. During the extrusion process, the controller 21 also provides instructions to the tool 23 regarding the movement the tool 23 must follow and the extrusion speed in each moment in order to extrude the ingredient in the pattern required by the recipe.

After this preparation sub-routine is ended, a test is made in step 293, to determine if the system 11 is ready to start the extrusion process. If the system 11 is not ready, control is transferred to step 295, where the extrusion mechanism waits until the system 11 is ready to go forward with the extrusion process. Once the system 11 is ready, control is transferred to step 297, where the extrusion process starts. Otherwise, if the system 11 is ready, control is transferred directly to step 297. Once the extrusion process has started, control is transferred from step 297 to step 299 where a further test is made to determine if the ingredient in the capsule 59 has been exhausted. If the ingredient is exhausted, control is transferred to step 301, where a capsule replacement sub-routine starts by putting the telescopic mechanism 511 into its rest position. Control is then transferred to step 303 where the capsule 59 in its capsule holder 53 is returned to its station 27 and control is transferred to step 305, where a test is made to determine if there is a need for the end user to replace the capsule 59. If there is such a need, control is transferred to step 307, where the system 11 waits for the user to replace the capsule 59. Afterwards, control is transferred back to step 281, where the preparation sub-routine starts over again. If there is no need for the user to change the capsule 59 as a result of the test made in step 305, control is transferred directly to step 283.

If the result of the test made in step 299 is that there is still some ingredient remaining in the capsule 59, a further test is conducted in step 309 to determine if the printing process with the ingredient contained in capsule 59 has ended. If the printing process has not ended yet, control is transferred back to step 297. Otherwise, control is transferred to step 310, where a mechanical suck-back element 513 is activated by a simple motor to pull back the piston to avoid the ingredient dripping from the capsule 59. Control is transferred then to step 311, where the telescopic mechanism 511 is put into its rest position, and control is transferred to step 313 where the capsule 59 in its capsule holder 53 is deposited back in its station 27 and the routine is exited.

d. Process Overview

An overview of the complete process carried out by the system 11 in printing a food product will now be described. The process starts with the end user selecting, downloading, or designing (collectively hereinafter referred to as “specifying”) a recipe through applications that the end user can access through the UI/UX 15 embedded in the system 11 or through any other device (tablet, smartphone, pc, etc. . . . ) connected to the system 11 via Wi-Fi. All relevant information related to the specified recipe (including the proper ingredients for the recipe) is then stored in the RWM 19. Once the recipe has been specified, and the information relevant thereto has been stored in the RWM 19, the UI/UX 15 displays a request to the end user to load the capsules 59 containing the proper ingredients; and the processor 21 proceeds to implement instructions to check through the capsule identification system 41 that all of the capsules 59 are in place, and also identifies this way which station 27 contains which capsule 59. The system 11 then retrieves from the RWM 19 all the relevant information related to the recipe and the ingredients being used, so the printing process can be setup.

Next, the processor 17 proceeds to send instructions to the controller 21 so the heating system 500 can heat each capsule 59 being used to the proper temperature (that is, its stable target temperature). Once the capsules 59 are at their stable target temperatures, the processor 17 sends instructions to the controller 21 for the tool 23 to fetch from the appropriate station 27 the capsule holder 53 with the capsule 59 holding the ingredient to be used first for the recipe, as previously described, and the extrusion job for the ingredient in the capsule 59 can start.

After the extrusion job with the capsule 59 holding the first ingredient is ended, the tool 23 exchanges the capsule 59 and its capsule holder 53 for the next capsule 59 in its capsule holder 53, as previously described, and this next capsule 59 is used to continue the printing process until the printing process is completed. In other words, the controller 21 controls the tool 23 in fetching the capsules 59 and their capsule holders 53 from and returning the capsules 59 and their capsule holders to the stations 27 in the repository 25, and to extrude the ingredients from the capsules 59 in the order and according to the pattern dictated by the recipe. Once the printing process is completed, all capsules 59 are returned to their original capsule stations 27 and the capsule heating systems 500, and extrusion mechanisms 511 are returned to their original states.

As will be appreciated by those of skill in the art, this process can be applied to print products other than food products which are composed of multiple materials and can be printed by AM printing techniques according to a set of directions.

e. Other Implementation Details

1. Terms

The detailed description contained herein is represented partly in terms of processes and symbolic representations of operations by a conventional programmable data processing apparatus. The processes and operations performed by the programmable data processing apparatus include the manipulation of signals by a processor and the maintenance of these signals within data packets and data structures resident in one or more media within memory storage devices. Generally, a “data structure” is an organizational scheme applied to data or an object so that specific operations can be performed upon that data or modules of data so that specific relationships are established between organized parts of the data structure.

A “data packet” is a type of data structure having one or more related fields, which are collectively defined as a unit of information transmitted from one device or program module to another. Thus, the symbolic representations of operations are the means used by those skilled in the art of computer programming and computer construction to most effectively convey teachings and discoveries to others skilled in the art.

For the purposes of this discussion, a process is generally conceived to be a sequence of steps executed by a programmable data processing apparatus and leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to representations of these signals as bits, bytes, words, information, data, packets, nodes, numbers, points, entries, objects, images, files or the like. It should be kept in mind, however, that these and similar terms are associated with appropriate physical quantities for computer operations, and that these terms are merely conventional labels applied to physical quantities that exist within and during operation of the programmable data processing apparatus.

It should be understood that manipulations within the programmable data processing apparatus are often referred to in terms such as issuing, sending, altering, adding, disabling, determining, comparing, reporting, and the like, which are often associated with manual operations performed by a human operator. The operations described herein are machine operations performed in conjunction with various inputs provided by a human operator or user who interacts with the programmable data processing apparatus.

2. Hardware

It should be understood that various types of programmable data processing apparatus may be used with program modules constructed in accordance with the teachings described herein. It may prove advantageous to construct a specialized apparatus to perform the method steps described herein with hard-wired logic or programs stored in nonvolatile memory, such as read only memory.

3. Program

In the preferred embodiment, the steps of the present invention are embodied in machine-executable instructions. The instructions can be used to cause a general-purpose or special-purpose processor which is programmed with the instructions to perform the steps of the present invention. Alternatively, the steps of the present invention might be performed by specific hardware components that contain hardwired logic for performing the steps, or by any combination of programmed computer components and custom hardware components.

The foregoing system may be conveniently implemented in a program or program module(s) that is based upon the diagrams and descriptions in this specification. No particular programming language has been required for carrying out the various procedures described above because it is considered that the operations, steps, and procedures described above and illustrated in the accompanying drawings are sufficiently disclosed to permit one of ordinary skill in the art to practice the present invention.

Moreover, there are many types of programmable data processing apparatus, computer languages, and operating systems which may be used in practicing the present invention and therefore no detailed computer program could be provided which would be applicable to all of these many different systems.

Programming for carrying out the invention thus can be implemented by programmers of ordinary skill in the art without undue experimentation after understanding the description herein.

4. Product

The method in accordance with the present invention may be provided as a computer program product which may include a machine-readable medium having stored thereon instructions which may be used to program a programmable data processing apparatus (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions.

5. Components

Computer implementation optionally includes at least one conventional programmable data processing apparatus having a processor, memory, storage, input devices, and display devices. Where any block or combination of blocks is implemented by a programmable data processing apparatus, it is done optionally by conventional means, whereby one skilled in the art of computer implementation could utilize conventional algorithms, components, and devices to implement the requirements and design of the invention provided herein. However, the invention also includes any new, unconventional implementation means.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

1-5. (canceled)

6. An additive manufacturing printer system for printing a product using a plurality of materials in a process defined by a set of directions, wherein each of the materials is contained in a respective capsule and has a plurality of parameters and rheological properties associated therewith, and wherein the parameters define how the printer system handles material with which it is associated, the printer system comprising:
a plurality of capsule holders, each of the capsule holders being configured to have a material-containing capsule removably inserted therein, the material-containing capsule having a tag integrated therein, encoded with a unique code associated with externally stored data;
a repository having a plurality of stations for releasably holding one of the capsule holders, a sensor for detecting whether the station is occupied by one of the capsule holders, and a tag reader for retrieving the code from the tag integrated in the capsule of a capsule holder occupying the station;
a tool movable to different position coordinates in an X-Y plane, including position coordinates opposite each of the stations;
an exchanger mechanism having a first part in the tool and a second part in each of the stations, wherein the first part and the second part are configured to cooperate with each other for effecting an exchange of one of the capsule holders and the capsule inserted therein between one of the stations and the tool;
an actuator located in the tool, for actuating extrusion of the material from a capsule inserted in a capsule holder held by the tool;
a controller for controlling movement and operation of the tool;
a processor for providing the controller with position coordinates for movement of the tool, instructions for operating the exchanger mechanism to effectuate the exchange of the capsule holders between the second part of the exchanger mechanism in the stations and the first part of the exchanger mechanism in the tool, and operation of the actuator; and
data storage for receiving and storing the code retrieved by the tag reader integrated into each of the capsules, storing data associated with each code, and storing the data gathered by the controller and the parameters associated with each material.

7. The printer system of claim 6, wherein:
each of the material-containing capsules has a known temperature evolution curve;
each of the capsule holders includes a capsule heating system for providing temperature data to the processor and adjusting the temperature of the material contained in the capsule inserted in the capsule holder, the capsule heating system having a known temperature evolution curve;
each of the capsule heating systems includes a connector for releasably connecting the capsule heating system to the tool when the capsule holder is held by the tool and for releasably connecting the capsule heating system to one of the stations when the capsule holder is held in the station;
the processor provides the controller with instructions for carrying out an optimal heating process for the material in each of the capsules, for capsules both in the capsule holders in the repository and in the tool, the heating process comprising the adjustment of the capsule heating system of each of the capsule holders via the connector of each of the capsule holders, based on the composition and known temperature evolution curve of the capsule inserted in each of the capsule holders, the temperature of the material in each of the capsules as determined by the temperature data provided by the capsule heating system of each of the capsule holders, the parameters and properties associated with the material in each of the capsules, and the directions; and
the capsule heating system of each of the capsule holders is controllable by the processor to achieve a stable target temperature in each of the capsules.

8. The printer system of claim 7, wherein each capsule heating system comprises a transducer for converting energy from some form other than heat energy into heat energy, a conducting layer positioned to conduct the heat energy to a capsule inserted into the capsule holder, an insulating layer positioned to prevent leakage of the heat energy away from the capsule holder, and a heat sensor for providing the processor with temperature data from which the temperature of the material contained in the capsule can be determined, and wherein the connector releasably connects the heat sensor and the transducer to the tool when the capsule holder is held by the tool and releasably connects the heat sensor and the transducer to one of the stations when the capsule holder is held in the station.

9. The printer system of claim 8, the heat sensor measures the temperature of the capsule holder.

10. A method for printing a product using the additive manufacturing printer system of claim 7, comprising the steps of:
in response to a user specifying a set of directions for a product to be printed, storing information relevant to printing of the product in the data storage;
using the processor to identify the material contained in each of the capsules, to associate each capsule with a respective station, and to determine whether all materials for the product are available in the stations;
using the processor to send instructions to the controller to heat each capsule to be used in the product according to an optimal heating process for the material in each of the capsules; and
sending instructions from the processor to the controller for the tool to fetch the capsules and their respective capsule holders from and return the capsules and their respective capsule holders to the repository using the exchanger mechanism, and to operate the actuator in the tool to extrude the materials from the capsules in an order dictated by the set of directions;
wherein the optimal heating process for the material in each of the capsules is carried out for capsules both in the capsule holders in the repository and in the tool, and comprises adjusting the capsule heating system of each of the capsule holders via the connector of each of the capsule holders, based on the composition and known temperature evolution curve of the capsule inserted in each of the capsule holders, the temperature of the material in each of the capsules as determined by the temperature data provided by the capsule heating system of each of the capsule holders, the parameters and properties associated with the material in each of the capsules, and the directions.

11. The method of claim 5, wherein one of the parameters of each material is the heating curve of the material, and the optimal heating process achieves a stable target temperature in each of the capsules by processor control of the heating system in each of the capsule holders using a proportional-integral-derivative algorithm that assesses the slope of the heating curve of the material in each of the capsules.

12. The method of claim 10, further comprising the step of using the processor to carry out a test to determine if the printing of the product is complete, each time the exchanger mechanism completes returning a capsule holder and the capsule therein to the respective station with which the capsule holder is associated.

13. The method of claim 10, further comprising the steps of:
using the capsule heating system to measure the temperature of the capsule holder;
communicating the temperature of the capsule holder measured by the capsule heating system to the processor; and
using the processor to infer the temperature of the material in the capsule from the temperature of the capsule holder measured by the capsule heating system.

14. The method of claim 10, further comprising the steps of using the processor to carry out a test to determine if a capsule in use in the tool has reached a desired printing temperature based on information fetched by the processor from the data storage, and if the capsule has not reached the desired printing temperature, using the capsule heating system to increase the temperature of the capsule to the desired printing temperature.

15. The method of claim 10, further comprising the steps of using the processor to carry out a test to determine if a capsule in a station has reached a desired station temperature based on information fetched by the processor from the data storage, and if the capsule has not reached the desired station temperature, using the capsule heating system to increase the temperature of the capsule to the desired station temperature.

16. The method of claim 10, wherein in the step of sending instructions from the processor to the controller, the processor determines the extrusion speed and deployment of the actuator in the tool using as an input the design being printed and an extrusion multiplier parameter for linearly modifying the extrusion speed throughout the printing process in accordance properties specific to each material, including at least one of viscosity, density, and chunkiness.
